(19) United States
(12) Patent Application Publication
(10) Pub. No.: US 2020/0271421 A1
(43) Pub. Date: Aug. 27, 2020

(54) ROBUST ANGLE ONLY NINE STATE TARGET STATE ESTIMATOR (TSE)

(71) Applicant: BAE SYSTEMS Information and Electronic Systems Integration Inc., Nashua, NH (US)

(72) Inventors: Quang M. LAM, Fairfax, VA (US); Ryan P. CARNEY, Manchester, NH (US); Michael J. CHOINIERE, Merrimack, NH (US)

(73) Assignee: BAE SYSTEMS Information and Electronic Systems Integration Inc., Nashua, NH (US)

(21) Appl. No.: 16/285,746

(22) Filed: Feb. 26, 2019

(51) Int. Cl. F41G 7/30; G06F 17/16

(52) U.S. Cl. CPC F41G 7/303; G06F 17/16

(57) ABSTRACT

The present system estimates target motion with nonzero acceleration (including maneuvering uncertainty) using angle only (AO) measurements. The present approach employs a mixed coordinate system framework by combining modified spherical coordinate (MSC) system and Reference Cartesian Coordinate (RCC) system to keep accurate information flowing from one frame to the other while eliminating the numerical sensitivity of the angle measurements to the TSE vector. This integrated coordinate systems framework is achieved due to the state vector information of two frames (RCC and MSC) is effectively preserved between processing cycles and state vector transformation steps. The AO TSE architecture and processing schemes are applicable to a wide class of passive sensors. The mixed coordinate system provides robust real-time slant range estimation in a bootstrap fashion, thus turning passive AO measurements into equivalent active sensor measurements with built-in recursive range information but with greatly improved TSE accuracy.

### FIELD OF THE DISCLOSURE

The present disclosure relates to target tracking and more particularly to indirectly providing improved range estimation using an angle only nine state target state estimator (TSE) in the presence of target acceleration.

### BACKGROUND OF THE DISCLOSURE

Angle only estimation typically requires an additional (active) sensor that can offer range information measurements, in order to improve or achieve the particular TSE system performance's required accuracy. For instance, an RF active seeker is usually required to assist a passive EO/IR seeker by offering additional range information in order to eliminate the weakness of the angle only estimation scheme if only an EO/IR sensor is employed. In this disclosure, no additional assistance from any active sensor is required, yet the system is able to produce a very high performance TSE. Despite many attempts conducted by other researchers to address the design challenge of angle only TSE in the presence of acceleration, their resulting TSE performance accuracy are still about several hundred meters (˜0.5 km) accuracy compared to the present disclosure having a sub-meter accuracy range.

The main challenge of angle only TSE design is the lack of range information due to angle only measurements available from passive EO/IR sensors. The lack of range information inherently prevents a complete mapping or transformation from the spherical coordinate system to Cartesian coordinate system. In the present context, the measurement matrix of the TSE (H(2×9) matrix) essentially relies on the accuracy of the Jacobian terms in order to provide an angle only measurements update to complete the TSE in Cartesian Coordinate System. As a result, the conventional angle only TSE performance accuracy is numerically dictated by the accuracy of those Jacobian terms, thereby limiting the estimation accuracy of the baseline TSE design approach.

Wherefore it is an object of the present disclosure to overcome the above-mentioned shortcomings and drawbacks associated with the conventional angle only target state estimators.

### SUMMARY OF THE DISCLOSURE

It has been recognized that the bearing and elevation angle measurement filtering problem arising from passive sensors (e.g., EO/IR seeker, passive sonar), also known as the angle only (AO) target tracking problem, is well-known in the target tracking and estimation community for the past two decades. This is especially true for 3-D target state estimation (TSE) solution accuracy in the presence of target maneuvering uncertainty so that it can deliver the correct TSE information to the guidance subsystem to compute an effective guided acceleration to guide the weapon to the target within an acceptable error basket. Researchers have continuously examined this problem at the root-cause level, i.e., inherent range unavailability and the compounded observability issue arising from the linearization measurement matrix H (i.e., a 2×9 matrix as a function of partial derivatives of two measured angles with respect to the TSE Cartesian coordinate state vector). This problem is further compounded when the target is not static or is having non-uniform motion (i.e., maneuvering uncertainty).

One aspect of the present disclosure is that the robust angle only 9 state EKF design proposed herein can be used as the backbone of the passive only sensor solution defined in an operation mode wherein active sensor (RF based) operation is not available due to unavailability or shut-down for the purpose of counter counter-measure (i.e., not broadcasting during a critical time duration). Without the robust angle only 9 state EKF of the present disclosure, inaccurate TSE will occur, thus affecting engagement capabilities.

Key contributions of this present disclosure are threefold: (1) Cohesive Integrated Architecture carrying the exact information from the Reference Cartesian Coordinate (RCC) to Modified Spherical Coordinate (MSC) while fulfilling the exact mapping from one frame to the other; (2) Nonlinear Jacobian based mapping functions developed herein are uniquely integrated into the above processing architecture to process and complete the entire information between two frames to maintain the implicit estimated range accuracy needed; and last but not least (3) the superior performance of the present AO solution tested and evaluated in a complex nonlinear weapon to target engagement simulation.

One aspect of the present disclosure is the system architecture precisely defining and interconnecting information of respective target state estimate (TSE) vectors (needed to be in RCC in order to work in concert with modern guidance laws) and measurement predictions (in MSC) between two key coordinate systems (i.e., RCC and MSC) so that the inherent range and observability deficiencies associated with the passive sensors can be eliminated.

One aspect of the present disclosure is an angle only (AO) target tracking and estimation method, comprising: updating angle only (AO) measurements in a modified spherical coordinate (MSC) system from a single passive sensor, wherein measurement updating uses a nine state matrix accounting for position, velocity, and acceleration each in 3 axes to address target maneuvering uncertainty; transforming data from the modified spherical coordinate (MSC) system to a reference Cartesian coordinate (RCC) system; time updating in the reference Cartesian coordinate (RCC) system; transforming data from the reference Cartesian coordinate (RCC) system to the modified spherical coordinate (MSC) system; and calculating the angle only (AO) measurements for a plurality of targets at a sensor interface level for use in guiding a projectile to each of the plurality of targets.

One embodiment of the angle only (AO) target tracking and estimation method is wherein measuring updating follows: εₖ=yₖ−C\hat{z}_{k|k-1}, where C=[0 1 0 0 0 0 0 0 0 0 0 1 0 0 0 0 0 0] is derivative free, \hat{z}_{k|k}=\hat{z}_{k|k-1}+Kεₖ, \hat{P}_{k|k}=\hat{P}_{k|k-1}−KC\hat{P}_{k|k-1}, K=\hat{P}_{k|k-1}C^{T}S⁻¹, and S=C\hat{P}_{k|k-1}C^{T}+Rₖ, where Rₖ is the sensor measurements noise covariance matrix.

Another embodiment of the angle only (AO) target tracking and estimation method is wherein a steady state 3-D position error in three axes is less than 1 meter. In some cases, the method is performed on-board a projectile using a single passive sensor. In certain embodiments, the single passive sensor is configured to track multiple targets.

Yet another embodiment of the angle only (AO) target tracking and estimation method is wherein the multiple targets are in motion. In certain embodiments, transforming data from the modified spherical coordinate (MSC) system to the reference Cartesian coordinate (RCC) system follows: \hat{x}_{k-1|k-1}=fₓ(\hat{z}_{k'1|k-1}). In some cases, transforming data from the reference Cartesian coordinate (RCC) system to the modified spherical coordinate (MSC) system follows: \hat{z}_{k|k-1}=f_{z}(\hat{x}_{k|k-1}).

Still yet another embodiment of the angle only (AO) target tracking and estimation method is wherein time updating in the reference Cartesian coordinate (RCC) system follows: \hat{x}_{k|k-1}=A\hat{x}_{k-1|k-1}+B_{w}wₖ+Bᵤuₖ where Bᵤ=B_{w} and A=a nine state extended Kaufman filter (EKF) target state estimator (TSE) where

$$[ \begin{matrix}x ( n + 1 ) \\ y ( n + 1 ) \\ z ( n + 1 ) \\ {v}_{x} ( n + 1 ) \\ {v}_{y} ( n + 1 ) \\ {v}_{z} ( n + 1 ) \\ {a}_{x} ( n + 1 ) \\ {a}_{y} ( n + 1 ) \\ {a}_{z} ( n + 1 )\end{matrix} ] = [ \begin{matrix}1 & 0 & 0 & t & 0 & 0 & 0.5 {t}^{2} & 0 & 0 \\ 0 & 1 & 0 & 0 & t & 0 & 0 & 0.5 {t}^{2} & 0 \\ 0 & 0 & 1 & 0 & 0 & t & 0 & 0 & 0.5 {t}^{2} \\ 0 & 0 & 0 & 1 & 0 & 0 & t & 0 & 0 \\ 0 & 0 & 0 & 0 & 1 & 0 & 0 & t & 0 \\ 0 & 0 & 0 & 0 & 0 & 1 & 0 & 0 & t \\ 0 & 0 & 0 & 0 & 0 & 0 & 1 & 0 & 0 \\ 0 & 0 & 0 & 0 & 0 & 0 & 0 & 1 & 0 \\ 0 & 0 & 0 & 0 & 0 & 0 & 0 & 0 & 1\end{matrix} ] [ \begin{matrix}x ( n ) \\ y ( n ) \\ z ( n ) \\ {v}_{x} ( n ) \\ {v}_{y} ( n ) \\ {v}_{z} ( n ) \\ {a}_{x} ( n ) \\ {a}_{y} ( n ) \\ {a}_{z} ( n )\end{matrix} ] + [ \begin{matrix}0 & 0 & 0 \\ 0 & 0 & 0 \\ 0 & 0 & 0 \\ 0 & 0 & 0 \\ 0 & 0 & 0 \\ 0 & 0 & 0 \\ \frac{t}{m} & 0 & 0 \\ 0 & \frac{t}{m} & 0 \\ 0 & 0 & \frac{t}{m}\end{matrix} ] [ \begin{matrix}{F}_{x} \\ {F}_{y} \\ {F}_{z}\end{matrix} ] + [ \begin{matrix}0 & 0 & 0 \\ 0 & 0 & 0 \\ 0 & 0 & 0 \\ 0 & 0 & 0 \\ 0 & 0 & 0 \\ 0 & 0 & 0 \\ \frac{t}{m} & 0 & 0 \\ 0 & \frac{t}{m} & 0 \\ 0 & 0 & \frac{t}{m}\end{matrix} ] [ \begin{matrix}{F}_{xd} \\ {F}_{y d} \\ {F}_{zd}\end{matrix} ]$$

\hat{P}_{k|k-1}=Φ_{k|k-1}\hat{P}_{k-1|k-1}Φ′_{k|k-1}+Qₖ₋₁^{msc}, where Qₖ₋₁ is expressed in RCC, and the rcc state vector is renamed, \hat{x}^{rcc} ₖ to \hat{x}ₖ;

$${Φ}_{k \vert k - 1} = \frac{\partial {z}_{k}}{\partial {z}_{k - 1}} {\vert}_{\hat{z}} = \frac{\partial {z}_{k}}{\partial {x}_{k}} \frac{\partial {x}_{k}}{\partial {x}_{k - 1}} \frac{\partial {x}_{k - 1}}{\partial {z}_{k - 1}} = {J}_{{f}_{z}} ( {\hat{x}}_{k} ) {AJ}_{fx} ( {\hat{z}}_{k - 1} ) ; and$$

$${Q}_{k - 1}^{MSC} = {J}_{fz} ( {\hat{x}}_{k \vert x} ) {Q}_{k - 1} {{J}_{fz} ( {\hat{x}}_{k \vert x} )}^{′} .$$

One embodiment of the angle only (AO) target tracking and estimation method is wherein a state vector in reference Cartesian coordinate (RCC) is defined as a 9×1 vector as follows:

$${x}^{rcc} = x = [ {\vec{r}}_{ts} \vert {\dot{\vec{r}}}_{ts} ] = [ {x}_{i} ] , i = 1 , 2 , … 9$$

$$where {\dot{\vec{r}}}_{ts} = {x}_{4} i + {x}_{5} j + {x}_{6} k = 3 \text{-} D$$

velocity vector of \vec{r}ₜₛ.

Another embodiment of the angle only (AO) target tracking and estimation method is wherein a state vector in modified spherical coordinate (MSC) is defined as a 9×1 vector as follows:

$${z}^{msc} = {[ {z}_{1} {z}_{2} {z}_{3} … {z}_{9} ]}^{′} = [ \frac{1}{r} \vert ϕ \vert θ \vert \frac{\dot{r}}{r} \vert ω {\vert \dot{θ} ]}^{′}$$

where r=∥\vec{r}ₜₛ∥=range=\sqrt{x₁²+x₂²+x₃²} ω=\dot{φ}cosθ.

Another aspect of the present disclosure is an angle only (AO) target tracking and estimation method comprising: initializing target states of a modified spherical coordinate (MSC) and reference Cartesian coordinate (RCC) system based on operating conditions of an engagement mission, the engagement mission including a plurality of projectiles and a plurality of targets; calculating modified spherical coordinate (MSC) measurement predictions, including \hat{z} as a function of reference Cartesian coordinate (RCC) and \hat{x} via a nonlinear mapping function f_{z}(\hat{x}); and calculating mixed coordinate system blocks, including J_{fx}, J_{fz}, Φ, and Q^{MSC}, to provide for individual mixed AO target state estimator (TSE) processing steps for use in angle only (AO) target tracking and estimation; wherein measurement updating in modified spherical coordinate (MSC) system uses a nine state matrix accounting for position, velocity, and acceleration each in 3 axes to address target maneuvering uncertainty.

One embodiment of the angle only (AO) target tracking and estimation method is where measurement updating follows: εₖ=yₖ−C\hat{z}_{k|k-1}, where C=[0 1 0 0 0 0 0 0 0 0 0 1 0 0 0 0 0 0] is derivative free, \hat{z}_{k|k}=\hat{z}_{k|k-1}+Kεₖ, \hat{P}_{k|k}=\hat{P}_{k|k-1}−KC\hat{P}_{k|k-1}, K=\hat{P}_{k|k-1}C^{T}S⁻¹, and S=C\hat{P}_{k|k-1}C^{T}+Rₖ, where Rₖ is the sensor measurements noise covariance matrix.

Another embodiment of the angle only (AO) target tracking and estimation method is wherein a steady state 3-D position error in three axes is less than 1 meter. In some cases, the method is performed on-board a projectile using a single passive sensor. In certain embodiments, the single passive sensor is configured to track multiple targets.

Yet another embodiment of the angle only (AO) target tracking and estimation method is wherein the multiple targets are in motion.

Yet another aspect of the present disclosure is a computer program product including one or more non-transitory machine-readable storage mediums having instructions encoded thereon for performing tracking of at least one target, the method comprising: updating angle only (AO) measurements in a modified spherical coordinate (MSC) system from a single passive sensor, wherein measurement updating uses a nine state matrix accounting for position, velocity, and acceleration each in 3 axes to address target maneuvering uncertainty; transforming data from the modified spherical coordinate (MSC) system to a reference Cartesian coordinate (RCC) system; time updating in the reference Cartesian coordinate (RCC) system; transforming data from the reference Cartesian coordinate (RCC) system to the modified spherical coordinate (MSC) system; and calculating the angle only (AO) measurements for a plurality of targets at a sensor interface level for use in guiding a projectile to each of the plurality of targets.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows a diagram of the definitions for a reference Cartesian coordinate (RCC) and a modified spherical coordinate (MSC) formulation according to one embodiment of the present disclosure.

FIG. 2 is a diagram of one embodiment of the mixed coordinates processing architecture for the system of the present disclosure.

FIG. 3 illustrates one embodiment of a closed-loop processing scheme of the mixed coordinate system approach of the present disclosure with detailed math operations per the individual steps.

FIG. 4 illustrates position estimation accuracy and error using a nine state angle only target state estimator in the X, Y, and Z axes according to the principles of the present disclosure.

FIG. 5 illustrates velocity estimation accuracy and error using a nine state angle only target state estimator in the X, Y, and Z axes according to the principles of the present disclosure.

FIG. 6 illustrates acceleration estimation accuracy and error using a nine state angle only target state estimator in the X, Y, and Z axes according to the principles of the present disclosure.

FIG. 7 shows a plot of eight potential targets, with six of the targets flagged to be hit, where multiple measurements of multiple targets are processed by one embodiment of the present disclosure.

### DETAILED DESCRIPTION OF THE DISCLOSURE

Kalman filtering, also known as linear quadratic estimation (LQE), is an algorithm that uses a series of measurements observed over time, containing statistical noise and other inaccuracies, and produces estimates of unknown variables that tend to be more accurate than those based on a single measurement alone, by estimating a joint probability distribution over the variables for each timeframe. As a general notion, prior knowledge of a state is used at a subsequent time step to predict that step (based on a physical model, for example). The step is updated with additional measurement data and there is an output estimate of the current state. This is an iterative process. Essentially, the algorithm works in a two-step process. In the prediction step, the Kalman filter produces estimates of the current state variables, along with their uncertainties. Once the outcome of the next measurement (necessarily corrupted with some amount of error, including random noise) is observed, these estimates are updated using a weighted average, with more weight being given to estimates with higher certainty. The algorithm is recursive. It can run in real time, using only the present input measurements and the previously calculated state and its uncertainty matrix; no additional past information is required.

The extended Kalman filter (EKF) is a nonlinear version of the Kalman filter which linearizes about an estimate of the current mean and covariance for a state. In the case of well-defined transition models, EKF is considered the de facto standard in the theory of nonlinear state estimation, such as for navigation systems and GPS. In the extended Kalman filter, the state transition and observation models don't need to be linear functions of the state but may instead be differentiable functions.

xₖ=f(xₖ₋₁, uₖ)+wₖ

zₖ=h(xₖ)+vₖ

Here wₖ and vₖ are the process and observation noises which are both assumed to be zero mean multivariate Gaussian noises with covariance Qₖ and Rₖ respectively. uₖ is the control vector.

The function f can be used to compute the predicted state from the previous estimate and similarly the function h can be used to compute the predicted measurement from the predicted state. However, f and h cannot be applied to the covariance directly. Instead a matrix of partial derivatives (the Jacobian) is computed. At each time step, the Jacobian is evaluated with current predicted states. These matrices can be used in the Kalman filter equations. This process essentially linearizes the non-linear function around the current estimate.

It is understood that tracking a maneuvering target using angle only measurements provided by an infrared (IR) camera is a challenging design problem. This is especially true for passive IR cameras used as a targeting sensor since its output measurements lack dynamic range information. As such, current target state estimator (TSE) solutions exhibit poor position estimation accuracy (e.g., about a 30 m position estimation error, or larger) depending, in part, on the engagement geometry.

The present disclosure provides a framework for using a mixed coordinate system (i.e., a combination of Modified Spherical Coordinate (MSC) and Reference Cartesian Coordinate System (RCC)) that is able to estimate the range information (i.e., not physically available from the IR sensor) in a recursive manner. This provides for the ability to more accurately address uncertainty in the position of a maneuvering target by extending a six state TSE (position and velocity each in three axes) into a nine state (position, velocity, and acceleration each in three axes) TSE.

In one embodiment of the system of the present disclosure, range is estimated via the MSC and recursively used as dynamic information to compute equivalent 3-D state vector information. In certain embodiments of the system of the present disclosure, a full mixed coordinate system (with dynamic range information calculation and exact Jacobian calculation between two coordinate systems (i.e., the MSC and the RCC) preserve the state information allowing the TSE to operate to produce increased positional accuracy.

The previous six state angle only (AO) TSE, using the Extended Kalman Filter (EKF), was not able to provide a needed accurate TSE vector for guidance subsystems to compute a commanded acceleration for a successful interception with a potential target. The prior six state TSE performance results for a target maneuvering case motivates the need to develop a new angle only filtering design to maintain the TSE estimation accuracy subject to target maneuvering uncertainty. For example, position estimation accuracy for six state model was degraded to an unacceptable error basket (>500 m after 1 second of the fly-out) and velocity estimation accuracy for the six state model was growing much larger than 3 m/s due to unaccountability of the target maneuvering situation.

The use of a mixed filter design provides several benefits. In one embodiment the system provides a real time (built-in) range estimation as part of the IR measurements, and reduces the sensitivity of the angle only tracking problem to help the TSE solution to stay within a reasonable estimation accuracy (e.g., <2 m vs 30 m or larger for conventional systems). Some benefits of the proposed approach include 1) improving the miss distance; 2) keeping the hardware cost down (without demanding range information from a laser range finder, or the like); and 3) the ability to maintain a TSE estimation performance accuracy to support a guidance subsystem to guide a weapon for a successful interception. In some cases, the success measured by a circular error probable (CEP).

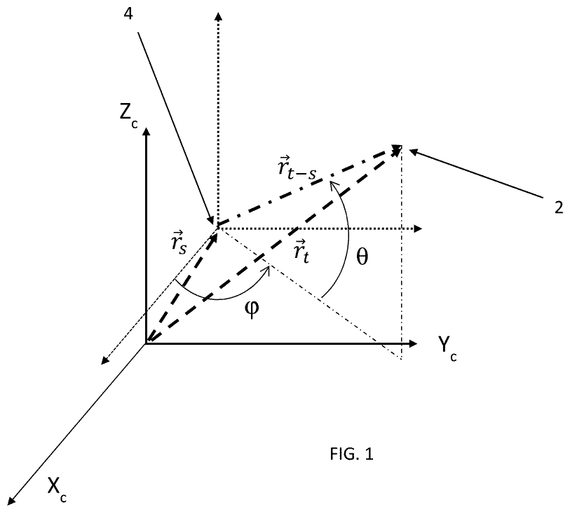

Referring to FIG. 1, a diagram of the definitions for the RCC and the MSC formulations according to one embodiment of the present disclosure is shown. More specifically, the state vector in RCC is defined as a 9×1 vector as follows:

$${x}^{rcc} = x = [ {\vec{r}}_{ts} \vert {\dot{\vec{r}}}_{ts} ] = [ {x}_{i} ] , i = 1 , 2 , … 9$$

$$where {\dot{\vec{r}}}_{ts} = {x}_{4} i + {x}_{5} j + {x}_{6} k = 3 \text{-} D$$

velocity vector of \vec{r}ₜₛ. The state vector in MSC is defined as a 9×1 vector as follows:

$${z}^{msc} = {[ {z}_{1} {z}_{2} {z}_{3} … {z}_{9} ]}^{′} = [ \frac{1}{r} \vert ϕ \vert θ \vert \frac{\dot{r}}{r} \vert ω {\vert \dot{θ} ]}^{′}$$

where r=∥\vec{r}ₜₛ∥=range =\sqrt{x₁²+x₂²+x₃²} ω=\dot{φ}cosθ. The EO/IR sensor 4 measures φ and θ used to calculate the location of the target 2 using the TSE of the present disclosure where the range information is provided via the mixed coordinate system approach described herein.

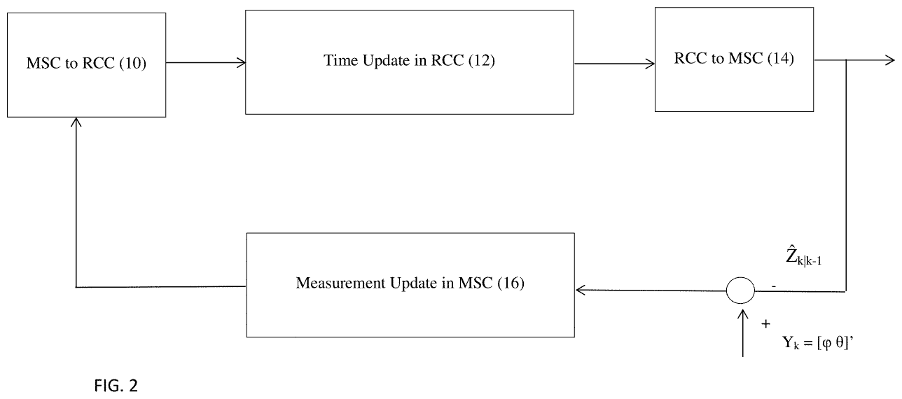

Referring to FIG. 2, a diagram of one embodiment of the mixed coordinates processing architecture of the present disclosure is shown. More specifically, the information in MSC is exactly transformed to RCC according to \hat{x}_{k-1|k-1}=fₓ(\hat{z}_{k-1|k-1})10.

In certain embodiments, the nonlinear function mapping of the MSC state to the RCC state, fₓ(z) is as follows:

$${X}_{1} = r cos θ cos ϕ = ( \frac{1}{{z}_{1}} ) cos ( {z}_{3} ) cos ( {z}_{2} )$$

$${x}_{2} = r cos θ sin ϕ = ( \frac{1}{{z}_{1}} ) cos ( {z}_{3} ) sin ( {z}_{2} )$$

$${x}_{3} = r sin θ = ( \frac{1}{{z}_{1}} ) sin ( {z}_{3} )$$

$${x}_{4} = \dot{r} cos θ cos ϕ - r \dot{θ} sin θ cos ϕ - r ω sin ϕ = ( \frac{1}{{z}_{1}} ) [ {z}_{4} cos ( {z}_{2} ) cos ( {z}_{3} ) - {z}_{5} sin ( {z}_{2} ) - {z}_{6} cos ( {z}_{2} ) sin ( {z}_{3} ) ]$$

$${x}_{5} = \dot{r} cos θ sin ϕ - r \dot{θ} sin θ sin ϕ + r ω cos ϕ = ( \frac{1}{{z}_{1}} ) [ {z}_{4} cos ( {z}_{2} ) cos ( {z}_{3} ) - {z}_{5} sin ( {z}_{2} ) - {z}_{6} cos ( {z}_{2} ) sin ( {z}_{3} ) ]$$

$${x}_{6} = \dot{r} sin θ + r \dot{θ} cos θ = ( \frac{1}{{z}_{1}} ) [ {z}_{4} sin ( {z}_{3} ) + {z}_{6} cos ( {z}_{3} ) ]$$

$${x}_{7} = ( {z}_{4}^{*} {sin ( {z}_{2} )}^{*} {z}_{5} + {cos ( {z}_{2} )}^{*} sin {\{ {z}^{3} )}^{*} {z}_{6} - {cos ( {z}_{2} )}^{*} {cos ( {z}_{3} )}^{*} {z}_{4} ) / {z}_{1}^{2} - ( {sin ( {z}_{2} )}^{*} {z}_{8} + {cos ( {z}_{2} )}^{*} {z}_{5}^{*} {z}_{5} - {cos ( {z}_{2} )}^{*} {cos ( {z}_{3} )}^{*} {z}_{7}^{*} + {cos ( {z}_{2} )}^{*} {sin ( {z}_{3} )}^{*} {z}_{9} + {cos ( {z}_{2} )}^{*} {cos ( {z}_{3} )}^{*} {z}_{6}^{*} {z}_{6} + {cos ( {z}_{3} )}^{*} {sin ( {z}_{2} )}^{*} {z}_{4}^{*} {z}_{5} + cos {\{ {z}_{2} )}^{*} {sin ( {z}_{3} )}^{*} {z}_{4}^{*} {z}_{6} - {sin ( {z}_{2} )}^{*} {sin ( {z}_{3} )}^{*} {z}_{6}^{*} {z}_{5} ) / {z}_{1}$$

$${x}_{8} = - ( {sin ( {z}_{2} )}^{*} {z}_{5}^{*} {z}_{5} - {cos ( {z}_{2} )}^{*} {z}_{8} - {cos ( {z}_{3} )}^{*} {sin ( {z}_{2} )}^{*} {z}_{7} + {sin ( {z}_{2} )}^{*} {sin ( {z}_{3} )}^{*} {z}_{9} - {cos ( {z}_{2} )}^{*} {cos ( {z}_{3} )}^{*} {z}_{4}^{*} {z}_{5} + {cos ( {z}_{2} )}^{*} {sin ( {z}_{3} )}^{*} {z}_{6}^{*} {z}_{5} + cos {(}_{z 3 )}^{*} {sin ( {z}_{2} )}^{*} {z}_{6}^{*} {z}_{6} + {sin ( {z}_{2} )}^{*} {sin ( {z}_{3} )}^{*} {z}_{4}^{*} {z}_{6} ) / {z}_{1} - ( {z}_{4}^{*} {cos ( {z}_{2} )}^{*} {z}_{5} + {cos ( {z}_{3} )}^{*} {sin ( {z}_{2} )}^{*} {z}_{4} - {sin ( {z}_{2} )}^{*} {sin ( {z}_{3} )}^{*} {z}_{6} ) / {z}_{1}^{2} \\ {x}_{9} = ( {cos ( {z}_{3} )}^{*} {z}_{6} + {sin ( {z}_{3} )}^{*} {z}_{4}^{*} {z}_{4} ) / {z}_{1}^{2} - ( {cos ( {z}_{3} )}^{*} {z}_{9} + {sin ( {z}_{3} )}^{*} {z}_{7} + {cos ( {z}_{3} )}^{*} {z}_{4}^{*} {z}_{6} - {sin ( {z}_{3} )}^{*} {z}_{6}^{*} {z}_{6} ) / {z}_{1} .$$

The time update step 12 is in RCC according to \hat{x}_{k|k-1}=A\hat{x}_{k-1|k-1}+B_{w}wₖ+Bᵤuₖ where Bᵤ=B_{w} and A=a nine state EKF TSE

$$[ \begin{matrix}x ( n + 1 ) \\ y ( n + 1 ) \\ z ( n + 1 ) \\ {v}_{x} ( n + 1 ) \\ {v}_{y} ( n + 1 ) \\ {v}_{z} ( n + 1 ) \\ {a}_{x} ( n + 1 ) \\ {a}_{y} ( n + 1 ) \\ {a}_{z} ( n + 1 )\end{matrix} ] = [ \begin{matrix}1 & 0 & 0 & t & 0 & 0 & 0.5 {t}^{2} & 0 & 0 \\ 0 & 1 & 0 & 0 & t & 0 & 0 & 0.5 {t}^{2} & 0 \\ 0 & 0 & 1 & 0 & 0 & t & 0 & 0 & 0.5 {t}^{2} \\ 0 & 0 & 0 & 1 & 0 & 0 & t & 0 & 0 \\ 0 & 0 & 0 & 0 & 1 & 0 & 0 & t & 0 \\ 0 & 0 & 0 & 0 & 0 & 1 & 0 & 0 & t \\ 0 & 0 & 0 & 0 & 0 & 0 & 1 & 0 & 0 \\ 0 & 0 & 0 & 0 & 0 & 0 & 0 & 1 & 0 \\ 0 & 0 & 0 & 0 & 0 & 0 & 0 & 0 & 1\end{matrix} ] [ \begin{matrix}x ( n ) \\ y ( n ) \\ z ( n ) \\ {v}_{x} ( n ) \\ {v}_{y} ( n ) \\ {v}_{z} ( n ) \\ {a}_{x} ( n ) \\ {a}_{y} ( n ) \\ {a}_{z} ( n )\end{matrix} ] + [ \begin{matrix}0 & 0 & 0 \\ 0 & 0 & 0 \\ 0 & 0 & 0 \\ 0 & 0 & 0 \\ 0 & 0 & 0 \\ 0 & 0 & 0 \\ \frac{t}{m} & 0 & 0 \\ 0 & \frac{t}{m} & 0 \\ 0 & 0 & \frac{t}{m}\end{matrix} ] [ \begin{matrix}{F}_{x} \\ {F}_{y} \\ {F}_{z}\end{matrix} ] + [ \begin{matrix}0 & 0 & 0 \\ 0 & 0 & 0 \\ 0 & 0 & 0 \\ 0 & 0 & 0 \\ 0 & 0 & 0 \\ 0 & 0 & 0 \\ \frac{t}{m} & 0 & 0 \\ 0 & \frac{t}{m} & 0 \\ 0 & 0 & \frac{t}{m}\end{matrix} ] [ \begin{matrix}{F}_{xd} \\ {F}_{y d} \\ {F}_{zd}\end{matrix} ]$$

\hat{P}_{k|k-1}=Φ_{k|k-1}\hat{P}_{k-1|k-1}Φ′_{k|k-1}+Qₖ₋₁^{msc}, where Qₖ₋₁ the rcc state vector is renamed, \hat{x}^{rcc}ₖ to \hat{x}ₖ;

$${Φ}_{k \vert k - 1} = \frac{\partial {z}_{k}}{\partial {z}_{k - 1}} {\vert}_{\hat{z}} = \frac{\partial {z}_{k}}{\partial {x}_{k}} \frac{\partial {x}_{k}}{\partial {x}_{k - 1}} \frac{\partial {x}_{k - 1}}{\partial {z}_{k - 1}} = {J}_{{f}_{z}} ( {\hat{x}}_{k} ) {AJ}_{fx} ( {\hat{z}}_{k - 1} ) ;$$

$${Q}_{k - 1}^{MSC} = {J}_{fz} ( {\hat{x}}_{k \vert x} ) {Q}_{k - 1} {{J}_{fz} ( {\hat{x}}_{k \vert x} )}^{′} .$$

Here, the J terms represent the Jacobian matrix of MSC and RCC states.

The Jacobian Jz is computed as follows where zᵢ and xᵢ, i=1, 2, . . . 9 (MSC and RCC state variables) are defined above.

$${J}_{x} ( {z}_{1} , {z}_{2} , {z}_{3} , … {z}_{9} ) = [ \begin{matrix}{J}_{x 11} & {J}_{x 12} & … & … & {J}_{x 19} \\ {J}_{x 21} & {J}_{x 22} & … & … & {J}_{x 29} \\ {J}_{x 31} & {J}_{x 32} & … & … & {J}_{x 39} \\ {J}_{x 41} & {J}_{x 42} & … & … & {J}_{x 49} \\ & … & … & … & \\ & … & … & … & \\ {J}_{x 91} & {J}_{x 92} & … & … & {J}_{x 99}\end{matrix} ]$$

$$where {J}_{xij} = \frac{\partial {x}_{i}}{\partial {z}_{j}} , i = 1 to 9 , \\ j = 1 to 9.$$

$${J}_{z} ( {x}_{1} , {x}_{2} , {x}_{3} , … {x}_{9} ) = [ \begin{matrix}{J}_{z 11} & {J}_{z 12} & … & … & {J}_{z 19} \\ {J}_{z 21} & {J}_{z 22} & … & … & {J}_{z 29} \\ {J}_{z 31} & {J}_{z 32} & … & … & {J}_{z 39} \\ {J}_{z 41} & {J}_{z 42} & … & … & {J}_{z 49} \\ & … & … & … & \\ & … & … & … & \\ {J}_{z 91} & {J}_{z 92} & … & … & {J}_{z 99}\end{matrix} ]$$

$$where {J}_{zij} = \frac{\partial {z}_{i}}{\partial {x}_{j}} , i = 1 to 9 , \\ j = 1 to 9.$$

Still referring to FIG. 2, following the time update a conversion from RCC to MSC 14 is completed according to \hat{z}_{k|k-1}=f_{z}(\hat{x}_{k|k-1}).

In certain embodiments, the nonlinear function mapping of the RCC state to the MSC state, f_{z}(x) is as follows:

$${Z}_{1} = \frac{1}{r} = \frac{1}{\sqrt{{x}_{1}^{2} + {x}_{2}^{2} + {x}_{3}^{2}}}$$

$${Z}_{2} = ϕ = a tan ( \frac{{x}_{2}}{{x}_{1}} )$$

$${z}_{3} = θ = a tan ( \frac{{x}_{3}}{\sqrt{{x}_{1}^{2} + {x}_{2}^{2}}} )$$

$${Z}_{4} = \frac{\dot{r}}{r} = \frac{{x}_{1} {x}_{4} + {x}_{2} {x}_{5} + {x}_{3} {x}_{6}}{{x}_{1}^{2} + {x}_{2}^{2} + {x}_{3}^{2}}$$

$${Z}_{5} = Ω = \dot{ϕ} cos θ = \frac{{x}_{1} {x}_{5} - {x}_{2} {x}_{4}}{{x}_{1}^{2} + {x}_{2}^{2}} cos ( a tan ( \frac{{x}_{3}}{\sqrt{{x}_{1}^{2} + {x}_{2}^{2}}} ) \\ {Z}_{6} = \dot{θ} = \frac{{x}_{6} ( {x}_{1}^{2} + {x}_{2}^{2} ) - {x}_{3} ( {x}_{1} {x}_{4} + {x}_{2} {x}_{5} )}{( {x}_{1}^{2} + {x}_{2}^{2} + {x}_{3}^{2} ) \sqrt{{x}_{1}^{2} + {x}_{2}^{2}}} \\ {z}_{7} = \frac{d ( \dot{r} )}{dt ( r )} = \frac{\ddot{r} r - \dot{r} \dot{r}}{{r}^{2}} = \frac{\ddot{r}}{r} - \frac{{\dot{r}}^{2}}{{r}^{2}} \\ {Z}_{8} = \dot{Ω} = \ddot{ϕ} cos θ - \dot{ϕ} sin θ \\ {Z}_{9} = \ddot{θ}$$

This data is fed into the measurement update phase of the process 16, where the measurements update is in MSC according to the following:

εₖ=yₖ−C\hat{z}_{k|k-1}, where C=[0 1 0 0 0 0 0 0 0 0 0 1 0 0 0 0 0 0] is derivative free.

\hat{z}_{k|k=\hat{z}|k-1}Kεₖ

\hat{P}_{k|k}\hat{P}_{k|k-1}−KC\hat{P}_{k|k-1}

K=\hat{P}_{k|k-1}C^{T}S⁻¹

S=C\hat{P}_{k|k-1}C^{T}+Rₖ, where Rₖ is the IR measurements noise covariance matrix. The cycle repeats itself by proceeding to the MSC to RCC transformation phase 10.

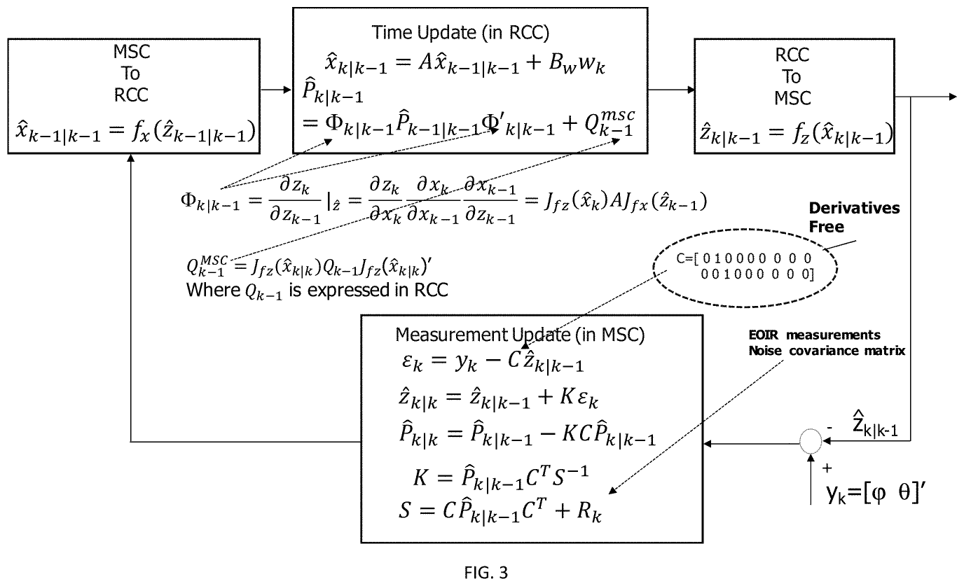

Referring to FIG. 3, one embodiment of a closed-loop processing scheme of the mixed coordinate system approach of the present disclosure with detailed math operations per the individual steps is shown.

In one embodiment of the system of the present disclosure, the main function for the nine state EKF are as follows:

function [X_k, P_k]=TSE_EKF_v2_9_state(X_k, P_k, y_k, Q, R, dT)

% Inputs

% X_k=previous state estimate in Cartesian coordinates (n×1)

% P_k=previous covariance matrix (n×n)

% y_k=observation from EOIR sensor z1: az z2: e1 (m×1)

% Q=process noise covariance matrix (n×n)

% R=observation error matrix (m×m)

% dT=sensor propagation time step

% Outputs

% X_k=current state estimate in Cartesian coordinates (n×1)

% P_k=current covariance matrix (n×n)

%%

X_prev=X_k;

Z_prev=f_z(X_prev);

%% 1) State Estimate Prediction (Time Update)

A=[eye(3), dT*eye(3), ½*dT̂2*eye(3);

zeros(3), eye(3), dT*eye(3);

zeros(3,6), eye(3)];

B=[zeros(6,3); dT*eye(3)];

X_k=A*X_prev; % X_k from A*X_k−1

Z_k=f_z(X_k); % Z_k from X_k

Phi=Jfz(X_k)*A*Jfx(Z_prev);

Q_mcs =Jfz(X_k)*Q*Jfz(X_k)′;

P_k=Phi*P_k*Phi′+Q_mcs;

%% 2) Observation Residual

C=zeros (2,9);

C(1,2)=1;

C (2,3)=1;

e=y_k−C*Z_k;

%% 3) Gain Matrix

S=C*P_k*C′+R; % (m×m)

K=P_k*C*Ŝ(−1); % (n×m)

%% 4) Update State Estimate Prediction

Z_k=Z_k+K*e; % update predicted state estimate (n×1)

X_k=f x(Z_k);

P_k=P_k−K*C*P_k; % update predicted covariance matrix (n×n)

end.

Fx formation: function X=f_x(Z)

z1=Z(1); z2=Z(2); z3=Z(3); z4=Z(4); z5=Z(5); z6=Z(6); z7=Z(7); z8=Z(8); z9=Z(9); X=zeros (9,1); X(1)=(cos(z2)*cos(z3))/z1; X(2)=(cos(z3)*sin(z2))/z1; X(3)=sin(z3)/z1; X(4)=−(z4*cos(z2)*cos(z3)+z1*z5*cos(z3)*sin(z2)+z1*z6*cos(z2)*sin(z3))/z1̂2; X(5)=−(z4*cos(z3)*sin(z2)−z1*z5*cos(z2)*cos(z3)+z1*z6*sin(z2)*sin(z3))/z1̂2; X(6)=−(z4*cos(z3)*sin(z2)−z1*z5*cos(z2)*cos(z3)+z1*z6*sin(z2)*sin(z3))/z1̂2; X(7)=−(z1*z7*cos(z2)*cos(z3)−2*z4̂2*cos(z2)*cos(z3)+z1̂2*z8*cos(z3)*sin(z2)+z1̂2*z9*cos(z2)*sin(z3)+z1̂2*z5̂2*cos(z2)*cos(z3)+z1̂2*z6̂2*cos(z2)*cos(z3)−2*z1̂2*z5*z6*sin(z2)*sin(z3)−2*z1*z4*z5*cos(z3)*sin(z2)−2*z1*z4*z6*cos(z2)*sin(z3))/z1̂3; X(8)=−(z1*z7*cos(z3)*sin(z2)−2*z4̂2*cos(z3)*sin(z2)−z1̂2*z8*cos(z2)*cos(z3)+z1̂2*z9*sin(z2)*sin(z3)+z1̂2*z5̂2*cos(z3)*sin(z2)+z1̂2*z6̂2*cos(z3)*sin(z2)+2*z1*z4*z5*cos(z2)*cos(z3) −2*z1*z4*z6*sin(z2)*sin(z3)+2*z1̂2*z5*z6*cos(z2)*sin(z3))/z1̂3; X(9)=−(z1*z7*sin(z3)−2*z4̂2*sin(z3)−z1̂2*z9*cos(z3)+z1̂2*z6̂2*sin(z3)+2*z1*z4*z6*cos(z3))/z1̂3; end.

Jacobian Fz: %% Jacobian of F_z(X) function Jfz=Jfz(X)

x1=X(1); x2=X(2); x3=X(3); x4=X(4); x5=X(5); x6=X(6); x7=X(7); x8=X(8); x9=X(9);

Jfz=zeros (9,9); Jfz(1,1)=−x1/(x1̂2+x2̂2+x3̂2)̂(3/2); Jfz(1,2)=−x2/(x1̂2+x2̂2+x3̂2)(3/2); Jfz(1,3)=−x3/(x1̂2+x2̂2+x3̂2)̂(3/2);

Jfz(2,1)=−x2/(x1̂2*(x2̂2/x1̂2+1)); Jfz(2,2)=1/(x1*(x2̂2/x1̂2+1));

Jfz(3,1)=−(x1*x3)/((x3̂2/(x1̂2+x2̂2)+1)*(x1̂2+x2̂2)̂(3/2)); Jfz(3,2)=−(x2*x3)/((x3̂2/(x1̂2+x2̂2)+1)*(x1̂2+x2̂2)̂(3/2)); Jfz(3,3)=1/((x3̂2/(x1̂2+x2̂2)+1)*(x1̂2+x2̂2)̂(1/2));

Jfz(4,1)=(3*x1*(x1*x4+x2*x5+x3*x6))/(x1̂2+x2̂2+x3̂2)̂(5/2)−x4/(x1̂2+x2̂2+x3̂2)(3/2); Jfz(4,2)=(3*x2*(x1*x4+x2*x5+x3*x6))/(x1̂2+x2̂2+x3̂2)̂(5/2)−x5/(x1̂2+x2̂2+x3̂2)(3/2); Jfz(4,3)=(3*x3*(x1*x4+x2*x5+x3*x6))/(x1̂2+x2̂2+x3̂2)̂(5/2)−x6/(x1̂2+x2̂2+x3̂2)̂(3/2); Jfz(4,4)=−x1/(x1̂2+x2̂2+x3̂2)̂(3/2); Jfz(4,5)=−x2/(x1̂2+x2̂2+x3̂2)̂(3/2); Jfz(4,6)=−x3/(x1̂2+x2̂2+x3̂2)(3/2);

Jfz(5, 1)=x5/(x1̂2+x2̂2)−(2*x1*(x1*x5−x2*x4))/(x1̂2+x2̂2)̂2; Jfz(5,2)=−x4/(x1̂2+x2̂2)−(2*x2*(x1*x5−x2*x4))/(x1̂2+x2̂2)̂2; Jfz(5,4)=−x2/(x1̂2+x2̂2); Jfz(5,5)=x1/(x1̂2+x2̂2);

Jfz(6,1)=(2*x1*x3̂2*(x6/(x1̂2+x2̂2)̂(1/2)−(x3*(x1*x4+x2*x5))/(x1̂2+x2̂2)̂(3/2)))/((x3̂2/(x1̂2+x2̂2)+1)̂2*(x1̂2+x2̂2)2)−((x1*x6)/(x1̂2+x2̂2)̂(3/2)+(x3*x4)/(x1̂2+x2̂2)(3/2)−(3*x1*x3*(x1*x4+x2*x5))/(x1̂2+x2̂2)̂(5/2))/(x3̂2/(x1̂2+x2̂2)+1); Jfz(6,2)=(2*x2*x3̂2*(x6/(x1̂2+x2̂2)̂(1/2)−(x3*(x1*x4+x2*x5))/(x1̂2+x2̂2)̂(3/2)))/((x3̂2/(x1̂2+x2̂2)+1)̂2*(x1̂2+x2̂2)̂2)−((x2*x6)/(x1̂2+x2̂2)̂(3/2)+(x3*x5)/(x1̂2+x2̂2)̂(3/2)−(3*x2*x3*(x1*x4+x2*x5))/(x1̂2+x2̂2)(5/2))/(x3̂2/(x1̂2+x2̂2)+1); Jfz(6,3)=−(x1*x4+x2*x5)/((x3̂2/(x1̂2+x2̂2)+1)*(x1̂2+x2̂2)̂(3/2))−(2*x3*(x6/(x1̂2+x2̂2)̂(1/2)−(x3*(x1*x4+x2*x5))/(x1̂2+x2̂2)̂(3/2)))/((x3̂2/(x1̂2+x2̂2)+1)2*(x1̂2+x2̂2)); Jfz(6,4)=−(x1*x3)/((x3̂2/(x1̂2+x2̂2)+1)*(x1̂2+x2̂2)̂(3/2)); Jfz(6,5)=−(x2*x3)/((x3̂2/(x1̂2+x2̂2)+1)*(x1̂2+x2̂2)(3/2)); Jfz(6,6)=1/((x3̂2/(x1̂2+x2̂2)+1)*(x1̂2+x2̂2)(1/2));

Jfz(7, 1)=(6*x4*(x1*x4+x2*x5+x3*x6))/(x1̂2+x2̂2+x3̂2)̂(5/2)−x7/(x1̂2+x2̂2+x3̂2)̂(3/2)−(15*x1*(x1*x4+x2*x5+x3*x6)̂2)/(x1̂2+x2̂2+x3̂2)̂(7/2)+(3*x1*(x1*x7+x2*x8+x3*x9+x4̂2+x5̂2+x6̂2))/(x1̂2+x2̂2+x3̂2)̂(5/2); Jfz(7,2)=(6*x5*(x1*x4+x2*x5+x3*x6))/(x1̂2+x2̂2+x3̂2)̂(5/2)−x8/(x1̂2+x2̂2+x3̂2)̂(3/2)−(15*x2*(x1*x4+x2*x5+x3*x6)̂2)/(x1̂2+x2̂2+x3̂2)̂(7/2)+(3*x2*(x1*x7+x2*x8+x3*x9+x4̂2+x5̂2+x6̂2))/(x1̂2+x2̂2+x3̂2)̂(5/2); Jfz(7,3)=(6*x6*(x1*x4 30 x2*x5+x3*x6))/(x1̂2+x2̂2+x3̂2)̂(5/2)−x9/(x1̂2+x2̂2+x3̂2)̂(3/2)−(15*x3*(x1*x4+x2*x5+x3*x6)̂2)/(x1̂2+x2̂2+x3̂2)̂(7/2)+(3*x3*(x1*x7+x2*x8+x3*x9+x4̂2+x5̂2+x6̂2))/(x1̂2+x2̂2+x3̂2)̂(5/2); Jfz(7,4)=(6*x1*(x1*x4+x2*x5+x3*x6))/(x1̂2+x2̂2+x3̂2)̂(5/2)−(2*x4)/(x1̂2+x2̂2+x3̂2)̂(3/2); Jfz(7,5)=(6*x2*(x1*x4+x2*x5+x3*x6))/(x1̂2+x2̂2+x3̂2)̂(5/2)−(2*x5)/(x1̂2+x2̂2+x3̂2)̂(3/2); Jfz(7,6)=(6*x3*(x1 *x4+x2*x5+x3*x6))/(x1̂2+x2̂2+x3̂2)̂(5/2)−(2*x6)/(x1̂2+x2̂2+x3̂2)̂(3/2); Jfz(7,7)=−x1/(x1̂2+x2̂2+x3̂2)̂(3/2); Jfz(7,8)=−x2/(x1̂2+x2̂2+x3̂2)̂(3/2); Jfz(7,9)=−x3/(x1̂2+x2̂2+x3̂2)̂(3/2);

Jfz(8, 1)=(2*x2*x4̂2−2*x2*x5̂2+3*x1̂2*x8+x2̂2*x8−2*x1*x2*x7−4*x1*x4*x5)/(x1̂2+x2̂2)̂2−(4*x1*(x1̂3*x8−x2̂3*x7+2*x1*x2*x4̂2−2*x1 *x2*x5̂2−x1̂2*x2*x7−2*x1̂2*x4*x5+x1 *x2̂2*x8+2*x2̂2*x4*x5))/(x1̂2+x2̂2)̂3; Jfz(8,2)=(2*x1*x4̂2−2*x1*x5̂2−x1̂2*x7−3*x2̂2*x7+2*x1 *x2*x8+4*x2*x4*x5)/(x1̂2+x2̂2)̂2−(4*x2*(x1̂3*x8−x2̂3*x7+2*x1*x2*x4̂2−2*x 1*x2*x5̂2−x1̂2*x2*x7−2*x1̂2*x4*x5+x1*x2̂2*x8+2*x2̂2*x4*x5))/(x1̂2+x2̂2)̂3; Jfz(8,4)=(2*x2̂2*x5−2*x1̂2*x5+4*x1*x2*x4)/(x1̂2+x2̂2)̂2; Jfz(8,5)=−(2*x1̂2*x4−2*x2̂2*x4+4*x1 *x2*x5)/(x1̂2+x2̂2)̂2; Jfz(8,7)=−(x1̂2*x2+x2̂3)/(x1̂2+x2̂2)̂2; Jfz(8,8)=(x1*x2̂2+x1̂3)/(x1̂2+x2̂2)̂2;

Jfz(9, 1)=((x6/(x1̂2+x2̂2)̂(1/2)−(x3*(x1*x4+x2*x5))/(x1̂2 +x2̂2)̂(3/2))*((2*x3̂2*x4)/(x1̂2+x2̂2)̂2−(4*x1*x3̂2*(2*x1 *x4+2*x2*x5))/(x1̂2 +x2̂2)̂3+(4*x1 *x3*x6)/(x1̂2+x2̂2)̂2))/(x3̂2/(x1̂2+x2̂2)+1)̂2−(((x3̂2*(2*x1*x4+2*x2*x5))/(x1̂2+x2̂2)2−(2*x3*x6)/(x1̂2+x2̂2))*((x1*x6)/(x1̂2+x2̂2)̂(3/2)+(x3*x4)/(x1̂2+x̂2)(3/2)−(3*x1 *x3*(x1*x4 +x2*x5))/(x1̂2+x2̂2)(5/2)))/(x3̂2/(x1̂2+x2̂2)+1)̂2−((x1*x9)/(x1̂2+x2̂2)̂(3/2)+(x3*x7)/(x1̂2+x2̂2)̂(3/2)+(2*x4*x6)/(x1̂2+x2̂2)̂(3/2)+(15*x1*x3*(x1*x4+x2*x5)̂2)/(x1̂2+x2̂2)̂(7/2)−(3*x1*x3*(2*x1*x7+2*x2*x8+2*x4̂2+2*x5̂2))/(2*(x1̂2+x2̂2)̂(5/2))−(6*x3*x4*(x1*x4+x2*x5))/(x1̂2+x2̂2)̂(5/2)−(3*x1*x6*(2*x1*x4+2*x2*x5))/(x1̂2+x2̂2)̂(5/2))/(x3̂2/(x1̂2+x2̂2)+1)+(2*x1*x3̂2*(x9/(x1̂2+x2̂2)̂(1/2)−(x6*(2*x1*x4+2*x2*x5))/(x1̂2+x2̂2)̂(3/2)+(3*x3*(x1*x4+x2*x5)2)/(x1̂2+x2̂2)̂(5/2)−(x3*(2*x1*x7+2*x2*x8+2*x4̂2+2*x5̂2))/(2*(x1̂2+x2̂2)̂(3/2))))/((x3̂2/(x1̂2+x2̂2)+1)̂2*(x1̂2+x2̂2)̂2)+(4*x1*x3̂2*((x3̂2*(2*x1*x4+2*x2*x5))/(x1̂2+x2̂2)2−(2*x3*x6)/(x1̂2+x2̂2))*(x6/(x1̂2+x2̂2)̂(1/2)−(x3*(x1*x4+x2*x5))/(x1̂2+x2̂2)̂(3/2)))/((x3̂2/(x1̂2+x2̂2)+1)̂3*(x1̂2+x2̂2)̂2); Jfz(9,2)=((x6/(x1̂2+x2̂2)̂(1/2)−(x3*( x1*x4+x2*x5))/(x1̂2+x2̂2)(̂3/2))*((2*x3̂2*x5)/(x1̂2+x2̂2)̂2−(4*x2*x3̂2*(2*x1*x4+2*x2*x5))/(x1̂2+x2̂2)̂3+(4*x2*x3*x6)/(x1̂2+x2̂2)̂2))/(x3̂2/(x1̂2+x2̂2)+1)̂2−(((x3̂2*(2*x1*x4+2*x2*x5))/(x1̂2+x2̂2)̂2−(2*x3*x6)/(x1̂2+x2̂2))*((x2*x6)/(x1̂2+x2̂2)̂(3/2)+(x3*x5)/(x1̂2 +x2̂2)̂(3/2) −(3*x2*x3*(x1*x4+x2*x5))/(x1̂2+x2̂2)̂(5/2)))/(x3̂2/(x1̂2+x2̂2)+1)̂2−((x2*x9)/(x1̂2+x2̂2)̂(3/2)+(x3*x8)/(x1̂2+x2̂2)̂(3/2)+(2*x5*x6)/(x1̂2+x2̂2)̂(3/2)+(15*x2*x3*(x1*x4+x2*x5)̂2)/(x1̂2+x2̂2)̂(7/2)−(3*x2*x3*(2*x1*x7+2*x2*x8+2*x4̂2+2*x5̂2))/(2*(x1̂2+x2̂2)̂(5/2))−(6*x3*x5*(x1*x4+x2*x5))/(x1̂2+x2̂2)̂(5/2)−(3*x2*x6*(2*x1*x4+2*x2*x5))/(x1̂2+x2̂2)̂(5/2))/(x3̂2/(x1̂2+x2̂2)+1)+(2*x2*x3̂2*(x9/(x1̂2+x2̂2)̂(1/2)−(x6*(2*x1*x4+2*x2*x5))/(x1̂2+x2̂2)̂(3/2)+(3*x3*(x1*x4 +x2*x5)2)/(x1̂2+x2̂2)̂(5/2)−(x3*(2*x1*x7+2*x2*x8+2*x4̂2+2*x5̂2))/(2*(x1̂2+x2̂2)̂(3/2))))/((x3̂2/(x1̂2+x2̂2)+1)̂2*(x1̂2+x2̂2)2)+(4*x2*x3̂2*((x3̂2*(2*x1*x4+2*x2*x5))/(x1̂2+x2̂2)̂2−(2*x3*x6)/(x1̂2+x2̂2))*(x6/(x1̂2+x2̂2)̂(1/2)−(x3*(x1*x4x2*x5))/(x1̂2+x2̂2)̂(3/2)))/((x3̂2/(x1̂2+x2̂2)+1)̂3*(x1̂2+x2̂2)̂2); Jfz(9,3)=((3*(x1*x4+x2*x5)̂2)/(x1̂2+x2̂2)̂(5/2)−(2*x1*x7+2*x2*x8+2*x4̂2+2*x5̂2)/(2*(x1̂2+x2̂2)̂(3/2)))/(x3̂2/(x1̂2+x2̂2)+1)−((x6/(x1̂2+x2̂2)̂(1/2)−(x3*(x1*x4+x2*x5))/(x1̂2+x2̂2)̂(3/2))*((2*x6)/(x1̂2+x2̂2)−(2*x3*(2*x1*x4+2*x2*x5)/(x1̂2+x2̂2)̂2))/(x3̂2/(x1̂2+x2̂2)+1)̂2−(2*x3*(x9/(x1̂2+x2̂2)̂(1/2)−(x6*(2*x1*x4+2*x2*x5))/(x1̂2+x2̂2)̂(3/2)+(3*x3*(x1*x4 +x2*x5)̂2)/(x1̂2+x2̂2)̂(5/2)−(x3*(2*x1*x7+2*x2*x8+2*x4̂2+2*x5̂2))/(2*(x1̂2+x2̂2)̂(3/2))))/((x3̂2/(x1̂2+x2̂2)+1)̂2*(x1̂2+x2̂2))−(((x3̂2*(2*x1*x4+2*x2*x5))/(x1̂2+x2̂2)̂2−(2*x3*x6)/(x1̂2+x2̂2))*(x1*x4+x2*x5))/((x3̂2/(x1̂2+x2̂2)+1)̂2*(x1̂2+x2̂2)̂(3/2))−(4*x3*((x3̂2*(2*x1*x4+2*x2*x5))/(x1̂2+x2̂2)̂2−(2*x3*x6)/(x1̂2+x2̂2))*(x6/(x1̂2+x2̂2)̂(1/2)−(x3*(x1*x4+x2*x5))/(x1̂2+x2̂2)̂(3/2)))/((x3̂2/(x1̂2+x2̂2)+1)̂3*(x1̂2+x2̂2)); Jfz(9,4)=(2*x1 *x3̂2*(x6/(x1̂2+x2̂2)̂(1/2)−(x3*(x1*x4+x2*x5))/(x1̂2+x2̂2)̂(3/2)))/((x3̂2/(x1̂2+x2̂2)+1)̂2*(x1̂2+x2̂2)̂2)−((2*x1*x6)/(x1̂2+x2̂2)̂(3/2)+(2*x3*x4)/(x1̂2+x2̂2)̂(3/2)−(6*x1*x3*(x1*x4+x2*x5))/(x1̂2+x2̂2)̂(5/2))/(x3̂2/(x1̂2+x2̂2)+1)−(x1*x3*((x3̂2*(2*x1*x4+2*x2*x5))/(x1̂2+x2̂2)̂2−(2*x3*x6)/(x1̂2+x2̂2)))/((x3̂2/(x1̂2+x2̂2)+1)̂2*(x1̂2+x2̂2)̂(3/2)); Jfz(9,5)=(2*x2*x3̂2*(x6/(x1̂2+x2̂2)̂(1/2)−(x3*(x1*x4+x2*x5))/(x1̂2+x2̂2)̂(3/2)))/((x3̂2/(x1̂2+x2̂2)+1)̂2*(x1̂2+x2̂2)̂2)−((2*x2*x6)/(x1̂2+x2̂2)̂(3/2)+(2*x3*x5)/(x1̂2+x2̂2)̂(3/2)−(6*x2*x3*(x1*x4+x2*x5))/(x1̂2+x2̂2̂(5/2))/(x3̂2/(x1̂2+x2̂2)+1)−(x2*x3*((x3̂2*(2*x1*x4+2*x2*x5))/(x1̂2+x2̂2)̂2−(2*x3*x6)/(x1̂2+x2̂2)))/((x3̂2/(x1̂2+x2̂2)+1)̂2*(x1̂2+x2̂2)̂(3/2)); Jfz(9,6)=((x3̂2*(2*x1*x4+2*x2*x5))/(x1̂2+x2̂2)̂2−(2*x3*x6)/(x1̂2+x2̂2))/((x3̂2/(x1̂2+x2̂2)+1)̂2*(x1̂2+x2̂2)̂(1/2))−(2*x1*x4+2*x2*x5)/((x3̂2/(x1̂2+x2̂2)+1)*(x1̂2+x2̂2)̂(3/2))−(2*x3*(x6/(x1̂2+x2̂2)̂(1/2)−(x3*(x1*x4+x2*x5))/(x1̂2+x2̂2)̂(3/2)))/((x3̂2/(x1̂2+x2̂2)+1)̂2*(x1̂2+x2̂2)); Jfz(9,7)=−(x1*x3)/((x3̂2/(x1̂2+x2̂2)+1)*(x1̂2+x2̂2)̂(3/2)); Jfz(9,8)=−(x2*x3)/((x3̂2/(x1̂2+x2̂2)+1)*(x1̂2+x2̂2)̂(3/2)); Jfz(9,9)=1/((x3̂2/(x1̂2+x2̂2)+1)*(x1̂2+x2̂2)̂(1/2)); end.

Jacobian Fx(z): %% Jacobian of F_x(Z) function Jfx=Jfx(Z)

z1=Z(1); z2=Z(2); z3=Z(3); z4=Z(4); z5=Z(5); z6=Z(6); z7=Z(7); z8=Z(8); z9=Z(9); Jfx=zeros(9,9);

Jfx(1,1)=−(cos(z2)*cos(z3))/z1̂2; Jfx(1,2)=−(cos(z3)*sin(z2))/z1; Jfx(1,3)=−(cos(z2)*sin(z3))/z1;

Jfx(2,1)=−(cos(z3)*sin(z2))/z1̂2; Jfx(2,2)=(cos(z2)*cos(z3))/z1; Jfx(2,3)=−(sin(z2)*sin(z3))/z1;

Jfx(3,1)=−sin(z3)/z1̂2; Jfx(3,3)=cos(z3)/z1;

Jfx(4,1)=(2*(z4*cos(z2)*cos(z3)+z1*z5*cos(z3)*sin(z2)+z1*z6*cos(z2)*sin(z3)))/z1̂3−(z5*cos(z3)*sin(z2)+z6*cos(z2)*sin(z3))/z1̂2; Jfx(4,2)=(z4*cos(z3)*sin(z2)−z1*z5*cos(z2)*cos(z3)+z1*z6*sin(z2)*sin(z3))/z1̂2; Jfx(4,3)=(z4*cos(z2)*sin(z3)−z1*z6*cos(z2)*cos(z3)+z1*z5*sin(z2)*sin(z3))/z1̂2; Jfx(4,4)=−(cos(z2)*cos(z3))/z1̂2; Jfx(4,5)=−(cos(z3)*sin(z2))/z1; Jfx(4,6)=−(cos(z2)*sin(z3))/z1;

Jfx(5,1)=(2*(z4*cos(z3)*sin(z2)−z1*z5*cos(z2)*cos(z3)+z1*z6*sin(z2)*sin(z3)))/z1̂3+(z5*cos(z2)*cos(z3)−z6*sin(z2)*sin(z3))/z1̂2; Jfx(5,2) =−(z4*cos(z2)*cos(z3)+z1*z5*cos(z3)*sin(z2)+z1*z6*cos(z2)*sin(z3))/z1̂2; Jfx(5,3) =−(z*1z5*cos(z2)*sin(z3)−z4*sin(z2)*sin(z3)+z1*z6*cos(z3)*sin(z2))/z1̂2; Jfx(5,4) =−(cos(z3)*sin(z2))/z1̂2; Jfx(5,5)=(cos(z2)*cos(z3))/z1; Jfx(5,6)=(sin(z2)*sin(z3))/z1 ;

Jfx(6,1)=(2*(z4*cos(z3)*sin(z2)−z1*z5*cos(z2)*cos(z3)+z1*z6*sin(z2)*sin(z3)))/z1̂3+(z5*cos(z2)*cos(z3)−z6*sin(z2)*sin(z3))/z1̂2; Jfx(6,2) =−(z4*cos(z2)*cos(z3)+z1*z5*cos(z3)*sin(z2)+z1*z6*cos(z2)*sin(z3))/z1̂2; Jfx(6,3) =−(z1*z5*cos(z2)*sin(z3)−z4*sin(z2)*sin(z3)+z1*z6*cos(z3)*sin(z2))/z1̂2; Jfx(6,4) =−(cos(z3)*sin(z2))/z1̂2; Jfx(6,5)=(cos(z2)*cos(z3))/z1; Jfx(6,6)=−(sin(z2)*sin(z3))/z1;

Jfx(7,1)=(3*(z1*z7*cos(z2)*cos(z3)−2*z4̂2*cos(z2)*cos(z3)+z1̂2*z8*cos(z3)*sin(z2)+z1̂2*z9*cos(z2)*sin(z3)+z1̂2*z5̂2*cos(z2)*cos(z3)+z1̂2*z6̂2*cos(z2)*cos(z3)2*z1̂2*z5*z6*sin(z2)*sin(z3)−2*z1*z4*z5*cos(z3)*sin(z2)−2*z1*z4*z6*cos(z2)*sin(z3)))/z1̂4−(z7*cos(z2)*cos(z3) +2*z1*z8*cos(z3)*sin(z2)−2*z4*z5*cos(z3)*sin(z2)+2*z1*z9*cos(z2)*sin(z3)−2*z4*z6*cos(z2)*sin(z3)+2*z1*z5̂2*cos(z2)*cos(z3)+2*z1*z6̂2*cos(z2)*cos(z3)−4*z1*z5*z6*sin(z2)*sin(z3))/z1̂3; Jfx(7,2)=(z*z7*cos(z3)*sin(z2)−2*z4̂2*cos(z3)*sin(z2)−z1̂2*z8*cos(z2)*cos(z3)+z1̂2*z9*sin(z2)*sin(z3)+z1̂2*z5̂2*cos(z3)*sin(z2)+z1̂2*z6̂2*cos(z3)*sin(z2)+2*z1*z4*z5*cos(z2)*cos(z3) −2*z1*z4*z6*sin(z2)*sin(z3)+2*z1̂2*z5*z6*cos(z2)*sin(z3))/z1̂3; Jfx(7,3)=(z1*z7*cos(z2)*sin(z3)−2*z4̂2*cos(z2)*sin(z3)−z1̂2*z9*cos(z2)*cos(z3)+z1̂2*z8*sin(z2)*sin(z3)+z1̂2*z5̂2*cos(z2)*sin(z3)+z1̂2*z6̂2*cos(z2)*sin(z3)+2*z1*z4*z6*cos(z2)*cos(z3)2*z1*z4*z5*sin(z2)*sin(z3)+2*z1̂2*z5*z6*cos(z3)*sin(z2))/z1̂3; Jfx(7,4)=(4*z4*cos(z2)*cos(z3)+2*z1*z5*cos(z3)*sin(z2)2*z1*z6*cos(z2)*sin(z3))/z1̂3; Jfx(7,5)=(2*z1*z4*cos(z3)*sin(z2)2*z1̂2*z5*cos(z2)*cos(z3)+2*z1̂2*z6*sin(z2)*sin(z3))/z1̂3; Jfx(7,6)=(2*z1*z4*cos(z2)*sin(z3)−2*z1̂2*z6*cos(z2)*cos(z3)+2*z1̂2*z5*sin(z2)*sin(z3))/z1̂3; Jfx(7,7)=−(cos(z2)*cos(z3))/z1̂2; Jfx(7,8)=−(cos(z3)*sin(z2))/z1; Jfx(7,9)=−(cos(z2)*sin(z3))/z1;

Jfx(8,1)=(3*(z1*z7*cos(z3)*sin(z2)−2*z4̂2*cos(z3)*sin(z2)−z1̂2*z8*cos(z2)*cos(z3)+z1̂2*z9*sin(z2)*sin(z3)+z1̂2*z5̂2*cos(z3)*sin(z2)+z1̂2*z6̂2*cos(z3)*sin(z2)2*z1*z4*z5*cos(z2)*cos(z3)−2*z1*z4*z6* sin(z2)*sin(z3)2*z1̂2*z5*z6*cos(z2)*sin(z3)))/z1̂4−(z7*cos(z3)*sin(z2)−2*z1*z8*cos(z2)*cos(z3)+2*z4*z5*cos(z2)*cos(z3)+2*z1*z9*sin(z2)*sin(z3)−2*z4*z6*sin(z2)*sin(z3)+2*z1*z5̂2*cos(z3)*sin(z2)+2*z1*z6̂2*cos(z3)*sin(z2)+4*z1*z5*z6*cos(z2)*(sin(z3))/z1̂3; Jfx(8,2)=−(z1*z7*cos(z2)*cos(z3)−2*z4̂2*cos(z2)*cos(z3)+z1̂2*z8*cos(z3)*sin(z2)+z1̂2*z9*cos(z2)*sin(z3)+z1̂2*z5̂2*cos(z2)*cos(z3)+z1̂2*z6̂2*cos(z2)*cos(z3) −2*z1̂2*z5*z6*sin(z2)*sin(z3)2*z1 *z4*z5*cos(z3)*sin(z2)−2*z1*z4*z6*cos(z2)*sin(z3))/ẑ3; Jfx(8,3)=(z1*z7*sin(z2)*sin(z3)−2*z4̂2*sin(z2)*sin(z3)−z1̂2*z8*cos(z2)*sin(z3)−z1̂2*z9*cos(z3)*sin(z2)+z1̂2*z5̂2*sin(z2)*sin(z3)+z1̂2*z6̂2*sin(z2)*sin(z3)+2*z1*z4*z5*cos(z2)*sin(z3) +2*z1*z4*z6*cos(z3)*sin(z2)−2*z1̂2*z5*z6*cos(z2)*cos(z3))/z1̂3; Jfx(8,4)=(4*z4*cos(z3)*sin(z2)−2*z1*z5*cos(z2)*cos(z3)+2*z1*z6*sin(z2)*sin(z3))/z1̂3; Jfx(8,5)=−(2*z1*z4*cos(z2)*cos(z3)+2*z1̂2*z5*cos(z3)*sin(z2)+2*z1̂2*z6*cos(z2)*sin(z3))/z1̂3; Jfx(8,6)=−(2*z1̂2*z5*cos(z2)*sin(z3)−2*z1*z4*sin(z2)*sin(z3)+2*z1̂2*z6*cos(z3)*sin(z2))/z1̂3; Jfx(8,7)=(cos(z3)*sin(z2))/z1̂2; Jfx(8,8)=(cos(z2)*cos(z3))/z1; Jfx(8,9) =-(sin(z2)*sin(z3))/z1;

Jfx(9,1)=(3*(z1*z7*sin(z3)−2*z4̂2*sin(z3)−z1̂2*z9*cos(z3)+z1̂2*z6̂2*sin(z3)+2*z1*z4*z6*cos(z3)))/z1̂4−(z7*sin(z3)−2*z1*z9*cos(z3)+2*z4*z6*cos(z3)+2*z1*z6̂2*sin(z3))/z1̂3; Jfx(9,3)=−(z1*z7*cos(z3)−2*z4̂2*cos(z3)+z1̂2*z9*sin(z3)+z1̂2*z6̂2*cos(z3)−2*z1*z4*z6*sin(z3))/z1̂3; Jfx(9,4)=(4*z4*sin(z3)−2*z1*z6*cos(z3))/z1̂3; Jfx(9,6)=−(2*z1*z4*cos(z3)+2*z1̂2*z6* sin(z3))/z1̂2; Jfx(9,7)=-sin(z3)/z1̂2; Jfx(9,9)=cos(z3)/z1; end.

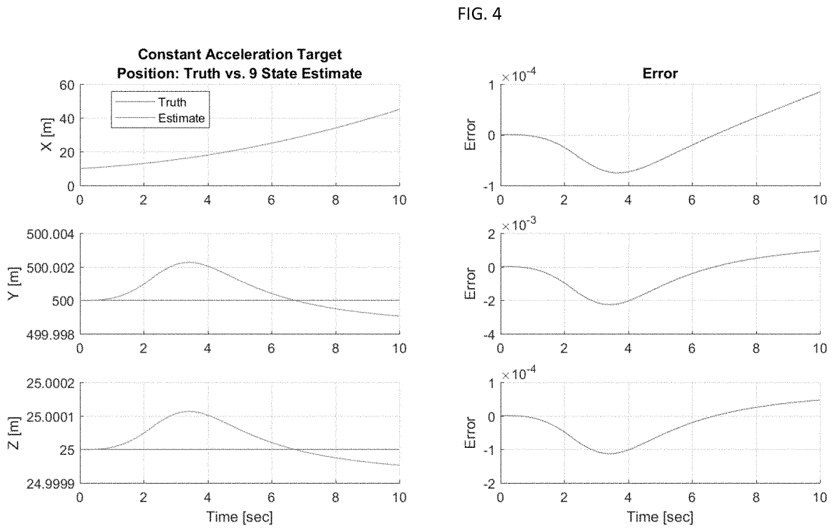

Referring to FIG. 4, position estimation accuracy and error using a nine state angle only target state estimator in the X, Y, and Z axes according to the principles of the present disclosure is shown. Its robust and high precision accuracy performance shown in FIG. 4 (right hand side plot) is smaller than 1e-3 meter while the left hand side figure shows the true position of the target in 3-D. The estimation vs truth is almost identical (and not able to differentiate the difference between them by eyes, i.e., right on top of one another axis by axis).

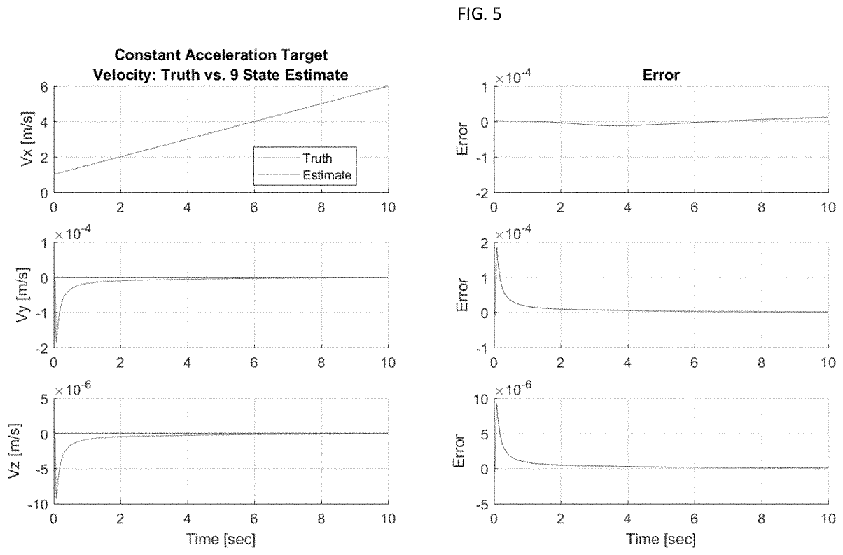

Referring to FIG. 5, velocity estimation accuracy and error using a nine state angle only target state estimator in the X, Y, and Z axes according to the principles of the present disclosure is shown. More specifically, the excellent performance estimation accuracy of the velocity component of the target motion in the X, Y, Z axes (i.e., Vx, Vy, Vz) is shown in FIG. 5. On the left hand side of FIG. 5 is the truth velocity of the target vs the actual estimation velocity component of the TSE. Since the target is accelerating in the x (Ax only) direction, only Vx is increasing in time (from 0 seconds to 10 seconds with a starting velocity Vx at lm/s and growing to 6 m/s at 10 seconds instant.) The target velocity in other two axes (Y and Z) are having zero velocities (Vy and Vz are equal zeros) and the 9 state TSE estimate matching that zero velocity right after seconds (i.e., after 2 seconds, the estimate of Vy and Vz settling to a zero m/s values). On the right hand side of FIG. 5 is the plotting of the velocity estimation errors in 3 axes. The velocity errors are very small (i.e., much less than 1e-3 m/s) which indicates the 9 state EKF TSE is doing quite well in reconstructing the target velocity vector in all axes.

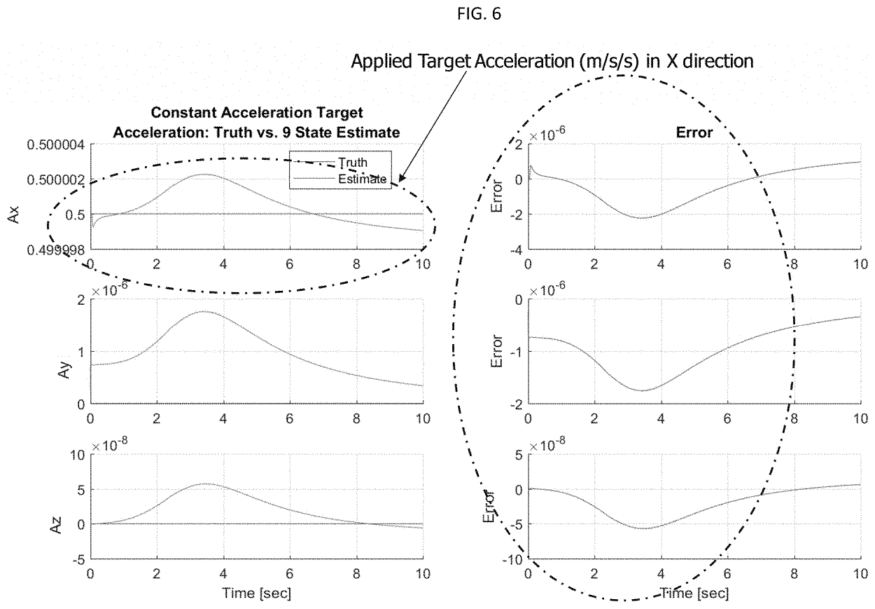

Referring to FIG. 6, acceleration estimation accuracy and error using a nine state angle only target state estimator in the X, Y, and Z axes according to the principles of the present disclosure is shown. More specifically, for the case of the target is accelerating at 0.5 m/s/s in the x direction (i.e., Ax only), the 9 state EKF TSE provides an accurate estimation of the target acceleration state vector as illustrated on FIG. 6. On Ay and Az, since the target is not accelerating in these two axes, the errors are extremely small (i.e., e-6 to e-8 magnitudes in m/s/s).

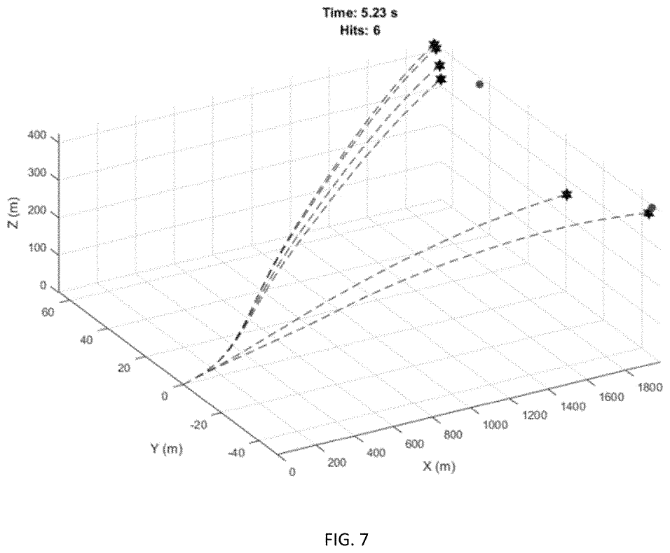

Referring to FIG. 7, a plot of eight potential targets, with six of the targets flagged to be hit (designated targets via weapon to target assignment subsystem), where multiple AO measurements of multiple targets are processed according to the principles of the present disclosure is shown. It is worth pointing out here that the 9 state AO TSE solution developed herein has demonstrated its accuracy and effectiveness in reconstructing the 8 targets (even in closely space targets situation) and delivered those highly accurate TSEs to guidance law and weapon target assignment subsystems to achieve a successful engagement of 6 weapons against 6 designated targets.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. An angle only (AO) target tracking and estimation method, comprising:
updating angle only (AO) measurements in a modified spherical coordinate (MSC) system from a single passive sensor, wherein measurement updating uses a nine state matrix accounting for position, velocity, and acceleration each in 3 axes to address target maneuvering uncertainty;
transforming data from the modified spherical coordinate (MSC) system to a reference Cartesian coordinate (RCC) system;
time updating in the reference Cartesian coordinate (RCC) system;
transforming data from the reference Cartesian coordinate (RCC) system to the modified spherical coordinate (MSC) system; and
calculating the angle only (AO) measurements for a plurality of targets at a sensor interface level for use in guiding a projectile to each of the plurality of targets.

2. The angle only (AO) target tracking and estimation method according to claim 1, wherein measuring updating follows: εₖ=yₖ −C\hat{z}_{k|k-1}, where C=[0 1 0 0 0 0 0 0 0 0 0 1 0 0 0 0 0 0] is derivative free, \hat{z}_{k|k}=\hat{z}_{k|k-1}+Kεₖ, \hat{P}_{k|k}=\hat{P}_{k|k-1}KC\hat{P}_{k|k-1}, K=\hat{P}_{k|k-1}C^{T}S⁻¹, and S=C\hat{P}_{k|k-1}C^{T}+Rₖ, where Rₖ is the sensor measurements noise covariance matrix.

3. The angle only (AO) target tracking and estimation method according to claim 1, wherein a steady state 3-D position error in three axes is less than 1 meter.

4. The angle only (AO) target tracking and estimation method according to claim 1, wherein the method is performed on-board a projectile using a single passive sensor.

5. The angle only (AO) target tracking and estimation method according to claim 4, wherein the single passive sensor is configured to track multiple targets.

6. The angle only (AO) target tracking and estimation method according to claim 5, wherein the multiple targets are in motion.

7. The angle only (AO) target tracking and estimation method according to claim 1, wherein transforming data from the modified spherical coordinate (MSC) system to the reference Cartesian coordinate (RCC) system follows: \hat{x}_{k-1|k-1}=fₓ(\hat{z}_{k-1|k-1}).

8. The angle only (AO) target tracking and estimation method according to claim 1, wherein transforming data from the reference Cartesian coordinate (RCC) system to the modified spherical coordinate (MSC) system follows: \hat{z}_{k|k-1}=f_{z}(\hat{x}_{k|k-1}).

9. The angle only (AO) target tracking and estimation method according to claim 1, wherein time updating in the reference Cartesian coordinate (RCC) system follows: \hat{x}_{k|k-1}=A\hat{x}_{k-1|k-1}+B_{w}wₖ+Bᵤuₖ where Bᵤ=B_{w} and A=a nine state extended Kaufman filter (EKF) target state estimator (TSE) where
$$[ \begin{matrix}x ( n + 1 ) \\ y ( n + 1 ) \\ z ( n + 1 ) \\ {v}_{x} ( n + 1 ) \\ {v}_{y} ( n + 1 ) \\ {v}_{z} ( n + 1 ) \\ {a}_{x} ( n + 1 ) \\ {a}_{y} ( n + 1 ) \\ {a}_{z} ( n + 1 )\end{matrix} ] = [ \begin{matrix}1 & 0 & 0 & t & 0 & 0 & 0.5 {t}^{2} & 0 & 0 \\ 0 & 1 & 0 & 0 & t & 0 & 0 & 0.5 {t}^{2} & 0 \\ 0 & 0 & 1 & 0 & 0 & t & 0 & 0 & 0.5 {t}^{2} \\ 0 & 0 & 0 & 1 & 0 & 0 & t & 0 & 0 \\ 0 & 0 & 0 & 0 & 1 & 0 & 0 & t & 0 \\ 0 & 0 & 0 & 0 & 0 & 1 & 0 & 0 & t \\ 0 & 0 & 0 & 0 & 0 & 0 & 1 & 0 & 0 \\ 0 & 0 & 0 & 0 & 0 & 0 & 0 & 1 & 0 \\ 0 & 0 & 0 & 0 & 0 & 0 & 0 & 0 & 1\end{matrix} ] [ \begin{matrix}x ( n ) \\ y ( n ) \\ z ( n ) \\ {v}_{x} ( n ) \\ {v}_{y} ( n ) \\ {v}_{z} ( n ) \\ {a}_{x} ( n ) \\ {a}_{y} ( n ) \\ {a}_{z} ( n )\end{matrix} ] + [ \begin{matrix}0 & 0 & 0 \\ 0 & 0 & 0 \\ 0 & 0 & 0 \\ 0 & 0 & 0 \\ 0 & 0 & 0 \\ 0 & 0 & 0 \\ \frac{t}{m} & 0 & 0 \\ 0 & \frac{t}{m} & 0 \\ 0 & 0 & \frac{t}{m}\end{matrix} ] [ \begin{matrix}{F}_{x} \\ {F}_{y} \\ {F}_{z}\end{matrix} ] + [ \begin{matrix}0 & 0 & 0 \\ 0 & 0 & 0 \\ 0 & 0 & 0 \\ 0 & 0 & 0 \\ 0 & 0 & 0 \\ 0 & 0 & 0 \\ \frac{t}{m} & 0 & 0 \\ 0 & \frac{t}{m} & 0 \\ 0 & 0 & \frac{t}{m}\end{matrix} ] [ \begin{matrix}{F}_{xd} \\ {F}_{y d} \\ {F}_{zd}\end{matrix} ]$$
\hat{P}_{k|k-1}=Φ_{k|k-1}\hat{P}_{k-1|k-1}Φ′_{k|k-1}+Qₖ₋₁^{msc}, where Qₖ₋₁ is expressed in RCC, and the rcc state vector is renamed, \hat{x}^{rcc}ₖ to \hat{x}ₖ;
$${Φ}_{k \vert k - 1} = \frac{\partial {z}_{k}}{\partial {z}_{k - 1}} {\vert}_{\hat{z}} = \frac{\partial {z}_{k}}{\partial {x}_{k}} \frac{\partial {x}_{k}}{\partial {x}_{k - 1}} \frac{\partial {x}_{k - 1}}{\partial {z}_{k - 1}} = {J}_{{f}_{z}} ( {\hat{x}}_{k} ) {AJ}_{fx} ( {\hat{z}}_{k - 1} ) ; and$$
$${Q}_{k - 1}^{MSC} = {J}_{fz} ( {\hat{x}}_{k \vert x} ) {Q}_{k - 1} {{J}_{fz} ( {\hat{x}}_{k \vert x} )}^{′} .$$

10. The angle only (AO) target tracking and estimation method according to claim 1, wherein a state vector in reference Cartesian coordinate (RCC) is defined as a 9×1 vector as follows:
$${x}^{rcc} = x = [ {\vec{r}}_{ts} \vert {\dot{\vec{r}}}_{ts} ] = [ {x}_{i} ] , i = 1 , 2 , … 9$$
$$where {\dot{\vec{r}}}_{ts} = {x}_{4} i + {x}_{5} j + {x}_{6} k = 3 \text{-} D$$
velocity vector of \vec{r}ₜₛ.

11. The angle only (AO) target tracking and estimation method according to claim 1, wherein a state vector in modified spherical coordinate (MSC) is defined as a 9×1 vector as follows:
$${z}^{msc} = {[ {z}_{1} {z}_{2} {z}_{3} … {z}_{9} ]}^{′} = [ \frac{1}{r} \vert ϕ \vert θ \vert \frac{\dot{r}}{r} \vert ω {\vert \dot{θ} ]}^{′} \\ where \\ r = ‖ {\vec{r}}_{ts} ‖ = range = \sqrt{{x}_{1}^{2} + {x}_{2}^{2} + {x}_{3}^{2}} \\ and ω = \dot{ϕ} cos θ .$$

12. An angle only (AO) target tracking and estimation method comprising:
initializing target states of a modified spherical coordinate (MSC) and reference Cartesian coordinate (RCC) system based on operating conditions of an engagement mission, the engagement mission including a plurality of projectiles and a plurality of targets;
calculating modified spherical coordinate (MSC) measurement predictions, including 2 as a function of reference Cartesian coordinate (RCC) and \hat{x} via a nonlinear mapping function f_{z}(\hat{x}); and
calculating mixed coordinate system blocks, including J_{fx}, J_{fz}, Φ, and Q^{MSC} , to provide for individual mixed AO target state estimator (TSE) processing steps for use in angle only (AO) target tracking and estimation;
wherein measurement updating in modified spherical coordinate (MSC) system uses a nine state matrix accounting for position, velocity, and acceleration each in 3 axes to address target maneuvering uncertainty.

13. The angle only (AO) target tracking and estimation method according to claim 12, where measurement updating follows: εₖ=yₖ−C\hat{z}_{k|k-1}, where C=[0 1 0 0 0 0 0 0 0 0 0 1 0 0 0 0 0 0] is derivative free, \hat{z}_{k|k}=\hat{z}_{k|k-1}+Kεₖ, \hat{P}_{k|k}=\hat{P}_{k|k-1}−KC\hat{P}_{k|k-1}, K=\hat{P}_{k|k-1}C^{T}S⁻¹, and S=C\hat{P}_{k|k-1}C^{T}+Rₖ, where Rₖ is the sensor measurements noise covariance matrix.

14. The angle only (AO) target tracking and estimation method according to claim 12, wherein a steady state 3-D position error in three axes is less than 1 meter.

15. The angle only (AO) target tracking and estimation method according to claim 12, wherein the method is performed on-board a projectile using a single passive sensor.

16. The angle only (AO) target tracking and estimation method according to claim 15, wherein the single passive sensor is configured to track multiple targets.

17. The angle only (AO) target tracking and estimation method according to claim 16, wherein the multiple targets are in motion.

18. A computer program product including one or more non-transitory machine-readable storage mediums having instructions encoded thereon for performing tracking of at least one target, the method comprising:
updating angle only (AO) measurements in a modified spherical coordinate (MSC) system from a single passive sensor, wherein measurement updating uses a nine state matrix accounting for position, velocity, and acceleration each in 3 axes to address target maneuvering uncertainty;
transforming data from the modified spherical coordinate (MSC) system to a reference Cartesian coordinate (RCC) system;
time updating in the reference Cartesian coordinate (RCC) system;
transforming data from the reference Cartesian coordinate (RCC) system to the modified spherical coordinate (MSC) system; and
calculating the angle only (AO) measurements for a plurality of targets at a sensor interface level for use in guiding a projectile to each of the plurality of targets.
